(19) United States
(12) Patent Application Publication
(10) Pub. No.: US 2020/0087177 A1
(43) Pub. Date: Mar. 19, 2020

(54) TAP WATER SUPPLY SYSTEM OF HYDROGEN-CONTAINING TAP WATER AND HYDROGEN-CONTAINING TAP WATER SUPPLYING METHOD

(71) Applicant: NTC Ltd., Hitachi-shi (JP)

(72) Inventors: Hiroaki Minakawa, Hitachi (JP); Satoru Takaishi, Hitachi (JP)

(21) Appl. No.: 16/554,428

(22) Filed: Aug. 28, 2019

(30) Foreign Application Priority Data
Sep. 13, 2018 (JP) 2018-171158

(51) Int. Cl. C02F 1/68; C01B 3/34

(52) U.S. Cl. CPC C02F 1/68; C25B 1/06; C01B 3/342

(57) ABSTRACT

A hydrogen gas generator, a hydrogen gas tank, and an aspirator are unitized into a one-unit configuration. Hydrogen gas generated by the hydrogen gas generator is mixed with a water stream, e.g., tap water without resorting to external power, using hydrogen gas produced in large amounts by a hydrogen gas generator, allowing to always supply hydrogen-containing water, e.g., tap water, to water users on need. The aspirator includes a nozzle part that increases the speed of the tap water flowing in a water conduit pipe, creating a lower pressure state below the pressure of the hydrogen gas tank by the Venturi effect and lowering the flow pressure of tap water to suck hydrogen gas into the flow of the tap water, thereby producing hydrogen-contained tap water is produced.

### TECHNICAL FIELD

The present invention relates to a hydrogen-containing tap water supply system and a method of supplying hydrogen-containing tap water.

### BACKGROUND ART

A hydrogen gas generator is a known art, which generator generates hydrogen gas from water-containing electrolyte using a photocatalyst. It has been proposed to use sunlight to generate hydrogen gas employing a photocatalyst. It is expected that the invented system may secure hydrogen gas as new energy on a large scale and may use the hydrogen gas as a water source to be used on a large scale.

The patent literature 1 discloses a hydrogen gas generator that is comprising a first chamber-forming part that forms a first chamber which accommodates a first electrode and an electrolyte, a second forming part that forms a second chamber which accommodates a second electrode and the electrolyte, a separation membrane that partitions between the first chamber and the second chamber to separate hydrogen gas from oxygen gas, and a direct current power source that connects between the first electrode and the second electrode.

Patent Literature 2 discloses a hydrogen gas generator comprising a container containing an aqueous solution of predetermined quality and a cathode and an anode electrically connected to each other, wherein the cathode and the anode are both immersed in the aqueous solution, wherein the anode is the photocatalytic layer on the surface of a p-type semiconductor layer of a solar cell having the p-n junction comprising a p-type semiconductor and an n-type semiconductor, wherein the photocatalytic layer is arranged to be able to receive irradiation of light energy and electrons and hole-pairs are excited when light energy irradiates the photocatalyst layer.

As a photocatalysts, various photocatalysts such as niobium nitride catalysts are known, and, even at present, many researchers research and develop photocatalysts used for hydrogen gas generation.

As has been known, the generated hydrogen gas is reserved in a hydrogen gas tank and supplied to fuel cell vehicles at a hydrogen station. Thus, hydrogen gas is expected to be used as new energy.

### LITERATURE OF CONVENTIONAL ART

### Patent Literature

### {Patent Literature 1}

Japanese Patent Publication No. 6216968

### {Patent Literature 2}

Unexamined Japanese Patent Publication No. 2003-238104

### SUMMARY OF INVENTION

### Technical Problem

When generation and storage of a large amount of hydrogen gas becomes available by a hydrogen gas generator described in Patent Literatures 1 and 2, supplying tap water such as hydrogen-containing water to water users will also become available. Much is known about the efficacy of hydrogen water. The hydrogen water is not only harmless to the human body but, as reported, also contributory greatly to the growth of plants.

In view of such points, an object of the present invention is to produce hydrogen gas in a large amount and to mix the hydrogen gas without the need for external driving power into flowing water such as tap water and to supply always needed hydrogen-contained water, e.g., tap water, to water users.

### Means for Solving the Problem

The present invention provides a tap water supply system wherein the tap water flowing through a water conduit pipe of tap water held at a predetermined water pressure is branched and supplied to each tap water user,

wherein the provided tap water supply system is comprising a hydrogen gas generator that produces hydrogen gas by separating the hydrogen gas from the oxygen gas and hydrogen gas which are produced from a water-containing electrolyte using photocatalyst,

wherein the hydrogen gas generator is comprising a first chamber-forming part that forms a first chamber which accommodates a first electrode and an electrolyte, and a second forming part that forms a second chamber which accommodates a second electrode and the electrolyte, and a separation membrane that partitions between a first chamber and a second chamber to separate the hydrogen gas from oxygen gas, and a direct current power supply that connects the first electrode and the second electrode,

wherein the tap water supply system is further comprising a hydrogen gas tank that reserves the produced hydrogen gas, and an aspirator arranged on a part of the water conduit pipe for tap water,

wherein the aspirator uses tap water flowing through the water conduit pipe as a driving source,

wherein the pressure of the tap water flowing through the water conduit pipe is maintained at a predetermined pressure,

wherein the aspirator has a narrow portion in the water conduit pipe that forms a nozzle part,

wherein hydrogen gas piping from the hydrogen gas tank is connected to around the periphery of the nozzle part,

wherein the aspirator uses the flow of tap water to create a depressurized state by Venturi effect,

wherein the aspirator increases the speed of tap water flow at the nozzle part formed in the narrowed portion of the water conduit pipe to create a lower pressure state below the pressure of the hydrogen gas tank by Venturi effect,

wherein the hydrogen gas is sucked into the depressurized tap water stream to be mixed with the tap water to produce hydrogen-contained tap water,

thereby the tap water supply system supplies the produced hydrogen-containing tap water to the tap water users.

The present invention also provides a tap water supply system wherein the tap water flowing through a water conduit pipe of tap water held at a predetermined water pressure is branched and supplied to each tap water user,

wherein the provided tap water supply system is comprising a hydrogen gas generator that produces hydrogen gas by separating the hydrogen gas from oxygen gas and hydrogen gas, which are produced from water-containing electrolyte using a photocatalyst,

wherein the hydrogen gas generator is comprising a first chamber-forming part that forms a first chamber which accommodates a first electrode and an electrolyte, and a second forming part that forms a second chamber which accommodates a second electrode and the electrolyte, and a separation membrane that partitions between the first chamber and the second chamber to separate the hydrogen gas from oxygen gas, and a direct current power supply that connects the first electrode and the second electrode,

wherein the tap water supply system is comprising a hydrogen gas tank that reserves the produced hydrogen gas, and an aspirator arranged on a part of the water conduit pipe for tap water,

wherein the aspirator uses tap water flowing through the water conduit pipe as a driving source,

wherein the pressure of the tap water flowing through the water conduit pipe is maintained at a predetermined pressure,

wherein the aspirator has a narrow portion in the water conduit pipe that forms a nozzle part,

wherein hydrogen gas piping from the hydrogen gas tank is connected to around the nozzle part,

wherein the aspirator uses the water pressure of tap water to create a depressurized state by Venturi effect,

wherein the hydrogen gas generator, the hydrogen gas tank, and the aspirator are unitized into one-unit configuration,

wherein the aspirator increases the speed of the tap water flow at the nozzle part in the narrowed portion of the water conduit pipe to create a lower pressure state below the pressure of the hydrogen gas tank by Venturi effect,

wherein the hydrogen gas is sucked into the depressurized tap water stream to be mixed with the tap water to produce hydrogen-containing tap water, thereby, the tap water supply system supplies the produced hydrogen-containing tap water to the tap water users.

The present invention provides a method for supplying tap water by a tap water supply system, the tap water supply system comprising a hydrogen gas generator that separates hydrogen gas from oxygen gas and hydrogen gas produced from a water-containing electrolyte using a photocatalyst, a hydrogen gas tank, and a hydrogen gas injection device,

wherein the hydrogen gas generator is comprising a first chamber-forming part that forms a first chamber which accommodates a first electrode and an electrolyte, and a second forming part that forms a second chamber which accommodates a second electrode and the electrolyte, and a separation membrane that partitions between the first chamber and the second chamber to separate the hydrogen gas from oxygen gas, and a direct current power supply that connects the first electrode and the second electrode,

wherein the hydrogen gas tank reserves the hydrogen gas produced by the hydrogen gas generator,

wherein the hydrogen gas injection device introduces the hydrogen gas reserved in the hydrogen gas tank into a water conduit pipe of tap water maintained at a predetermined water pressure,

wherein the tap water supply system branches the tap water flowing through the water conduit pipe and supplies to each tap water user,

wherein the tap water supply system has an aspirator arranged on a part of the water conduit pipe,

wherein the aspirator uses the tap water maintained at a predetermined water pressure flowing through the water conduit pipe as a driving source for injecting hydrogen gas,

wherein the aspirator has a narrow portion in the water conduit pipe that forms a nozzle part,

wherein a hydrogen gas piping from the hydrogen gas tank is connected to around the nozzle part,

wherein the aspirator, which produces depressurized state by Venturi effect using the flow of the tap water, is used as the hydrogen gas injector,

wherein the aspirator increases the speed of tap water flow at the nozzle part in the narrowed portion of the water conduit pipe to create a lower pressure state below the pressure of the hydrogen gas tank by Venturi effect,

wherein the hydrogen gas is sucked into the depressurized tap water stream and is mixed with the tap water to produce hydrogen-containing tap water,

wherein the produced hydrogen-containing tap water is supplied to tap water users.

Further, the present invention provides a method for supplying tap water by a tap water supply system, the tap water supply system comprising a unitized configuration including a hydrogen gas generator that generates the hydrogen gas from water-containing electrolyte using photocatalyst, a hydrogen gas tank, and a hydrogen gas injection device,

wherein the hydrogen gas generator is comprising a first chamber-forming part that forms a first chamber which accommodates a first electrode and an electrolyte, and a second forming part that forms a second chamber which accommodate a second electrode and the electrolyte, and a separation membrane that partitions between the first chamber and the second chamber to separate the hydrogen gas from oxygen gas, and a direct current power supply that connects the first electrode and the second electrode,

wherein the hydrogen gas tank reserves the hydrogen gas produced by the hydrogen gas generator,

wherein the hydrogen gas injection device introduces the hydrogen gas reserved in the hydrogen gas tank into a water conduit pipe of tap water maintained at a predetermined water pressure,

wherein the hydrogen-containing tap water supply system branches the tap water flowing through the water conduit pipe and supplies the branched tap water to each tap water user,

wherein the hydrogen-containing tap water supply system is comprising the hydrogen gas generator, hydrogen gas tank, and an aspirator arranged on a part of the tap water conduit pipe,

wherein the tap water in the water conduit pipe maintained at a predetermined water pressure is used as a driving source for the aspirator,

wherein the aspirator has a narrow portion in the water conduit pipe that forms a nozzle part in the water conduit pipe,

wherein a hydrogen gas piping from the hydrogen gas tank is connected to around the nozzle part,

wherein the aspirator, which produces depressurized state by Venturi effect using the flow of the tap water, the hydrogen gas generator, and the hydrogen gas tank are unitized into one-unit configuration,

wherein the aspirator increases the speed of the tap water flow at the nozzle part in the narrowed portion of the water conduit pipe to create a lower pressure state by Venturi effect below the pressure of the hydrogen gas tank,

wherein the hydrogen gas is sucked into the depressurized tap water stream and the hydrogen gas is mixed with the tap water to produce hydrogen-containing tap water,

thereby, the tap water supply system supplies the produced hydrogen-containing tap water to the hydrogen tap water users.

### Advantageous Effect of the Invention

According to the present invention, by unitizing the hydrogen gas generator, the hydrogen gas tank, and the aspirator into one-unit configuration, the hydrogen gas can be generated near the user of water, e.g., tap water, and the generated hydrogen gas is immediately used for the water such as tap water having a reduced escape of hydrogen gas. Further, unitizing the aspirator within the one-unit configuration allows hydrogen gas to mix with water, i.e., tap water, using the pressure of water, i.e., the pressure of tap water.

This makes it possible to mix hydrogen gas with water, e.g., tap water, without using an external power while using hydrogen gas generated in large amounts by a hydrogen gas generator employing a photocatalyst. With this, hydrogen-containing water, e.g., tap water, can always be supplied to the user when needed.

### BRIEF DESCRIPTION OF DRAWINGS

FIG. 1 This figure describes the concept of the present invention.

FIG. 2 This figure shows the system configuration of an embodiment example of a tap water supply system by the present invention.

### DESCRIPTION OF EMBODIMENTS

Hereinafter, embodiments of the present invention will be described based on the drawings.

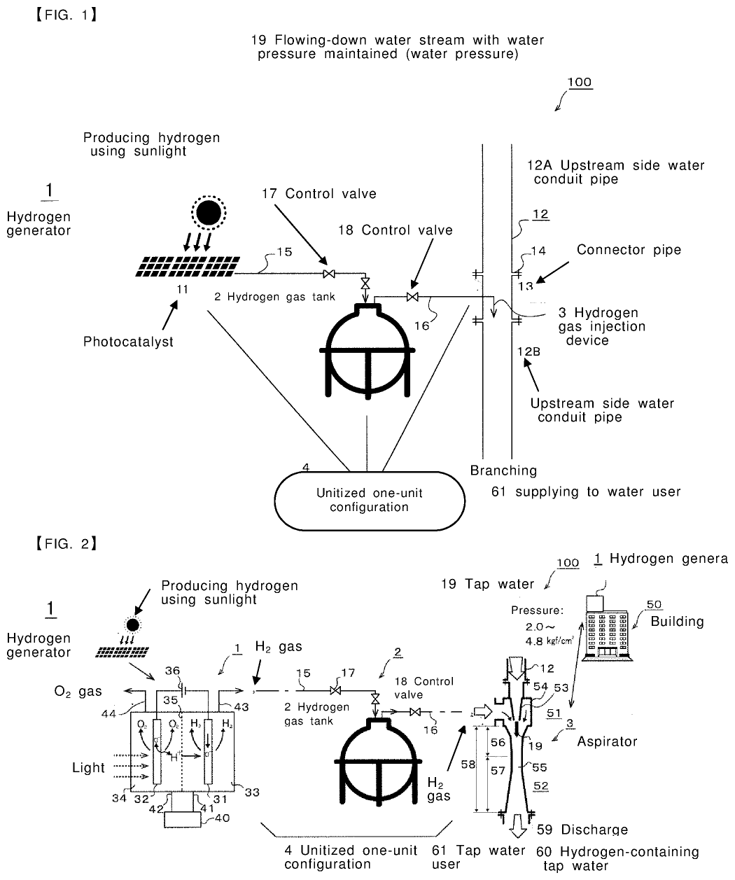

FIG. 1 is the figure to describe the concept of the present invention.

In FIG. 1, a water supply system 100 of the present invention is unitized into a one-unit configuration 4 comprising a hydrogen gas generator 1, a hydrogen gas tank 2, and a hydrogen gas injection device 3.

In the hydrogen generator 1, a photocatalyst 11 is used to generate hydrogen gas by the photocatalyst using solar light.

A hydrogen gas tank 2 is a spherical container for which a steel material having a durability to hydrogen gas is used.

The water supply system 100 is applied to a system, in which the water flows in the water conduit pipe held at a predetermined water pressure is branched and the branched water stream is supplied to each water user. In the system, the hydrogen gas injection device 3 is installed on a part of a water conduit pipe 12.

The upstream side of the water conduit pipe 12 is an upstream side water conduit pipe 12A and the downstream side of the water conduit pipe 12 is a downstream side water conduit pipe 12B.

The hydrogen gas injection device 3 has a connector pipe 13 that connects the upstream water conduit pipe 12A and the downstream side water conduit pipe 12B by a connection 14.

The hydrogen gas generator 1 and the hydrogen gas tank 2 are connected with a piping 15, and the hydrogen gas tank 2 and the hydrogen injection device 3 are connected with a piping 16,

and a control valve 17 and a control valve 18 are provided respectively on the piping systems 15 and 16 for controlling the hydrogen gas flow.

Instead of the piping 16 provided between the hydrogen gas tank 2 and the hydrogen gas injection device 3, a hydrogen gas transportation vehicle can be employed to convey the hydrogen gas in the hydrogen gas tank to the hydrogen gas injection device 3.

In the water conduit pipe 12, a water flow 19 flows, the water pressure of which in the water conduit pipe is held at a predetermined pressure, and the water flow serves as a driving source of hydrogen gas injection.

By this way, the water supply system is enabled to produce the hydrogen-containing water,

wherein the water flow in the water conduit pipe held at a predetermined water pressure is branched and the branched water flow is supplied to each water user,

wherein the water supply system has the unitized one-unit configuration 4 comprising the hydrogen gas generator 1 that separates hydrogen gas form oxygen gas and hydrogen gas produced from the water-containing electrolyte using photocatalyst, the hydrogen gas tank 2 that reserves produced hydrogen gas, and the hydrogen gas injection device 3 that injects the hydrogen gas in the water conduit pipe using the water flow as the driving source,

wherein the hydrogen gas is sucked into the stream of water flow to cause the hydrogen gas mixed with the water flow.

The unitized configuration allows to supply hydrogen-contained water, e.g., tap water, to the tap water user always needed by producing hydrogen gas in the vicinity of the tap water user. The tap water user may include a tap water user in a building. In this case, the unitized one-unit configuration 4 may be provided on the rooftop of such building.

As the users of the tap water, other than in-building, may be residents in vehicles, farms, and fishing ports.

FIG. 2 describes the configuration of the tap water supply system 100 according to the present invention.

For the elements shown in the configuration illustrated in FIG. 1 are given the same numerals. In FIG. 2, the hydrogen gas injection device 3 is expressed as an aspirator 3, because the aspirator is used as an example of the hydrogen injection device 3. FIG. 2 also shows that a building, on which the hydrogen generator 1 is provided, is illustrated as a building 20 to indicate that a one-unit configuration 41 may be provided on the rooftop of the building 20. FIG. 2 further shows that a tap water 19 may be used as an example of a water flow 19 flowing inside the water conduit pipe with the water pressure inside the water conduit pipe maintained at a predetermined pressure. In this case, the tap water serves as a driving source for hydrogen gas injection.

The hydrogen gas generator 1, which separates hydrogen gas from oxygen gas and hydrogen gas both produced form water-contained electrolyte using photocatalyst, is comprising a first chamber forming part that forms a first chamber 33, which accommodates an electrolyte and a first electrode 31, a second forming part that forms a second chamber 34, which accommodates the electrolyte and a second electrode 32, a separation membrane 35, which partitions between the first chamber 33 and the second chamber 34, separates hydrogen gas from oxygen gas, and a direct current power supply 36 that connects the first electrode 31 and the second electrode 32.

The direct current power supply 36 applies a bias voltage across two electrodes 31 and 32. The negative pole of the direct current power supply 36 is connected to the first electrode 31 and the positive pole of the direct current power supply 36 is connected to the second electrode 32.

An electrolyte supplying device 40 supplies water-containing electrolyte to two chambers, the first chamber 33 and the second chamber 34. The electrolyte supplying device 40 is connected to the first chamber 33 through a first feeding path 41 and to the second chamber 34 through a second feeding path 42.

As a water-containing electrolyte, an aqueous solution of NaSO₄, which allows conduction of protons (H⁺), is used. Other aqueous solutions may be used.

The separation membrane 35 is a thin-film that limits the passage of gas, wherein the membrane prevents the hydrogen gas generated at the first electrode 31 from passing to the second electrode 32 and further prevents the oxygen gas generated at the second electrode 32 from passing to the first electrode 31.

By this mechanism, the produced hydrogen gas and the oxygen gas are separated.

The electrons produced at the second electrode 32 move to the direct current power supply 36, and electrons are supplied from the direct current power supply 36 to the first electrode 31. Protons pass through the separation membrane 35 and move to the first electrode 31.

The protons moved to the first electrode 31 combine with the electrons at the first electrode 31 to generate hydrogen gas. The generated hydrogen gas is sent out from a first gas flow channel 43 and is led to the hydrogen tank 2 through the piping 15 and reserved.

The oxygen gas is discharged from a second gas flow channel 44 connected to the second chamber 34 and is reserved in an oxygen tank not illustrated.

The hydrogen gas generator 1 of this kind of configuration is a known art, which therefore would not require further description.

The aspirator is used as the hydrogen gas injection device. As a device to produce the decompressed state by the same principle as the aspirator, an ejector has been known.

The upstream side of the aspirator 3 is connected to the upstream side tap water conduit pipe 12A and the downstream side of the aspirator 3 is connected to the downstream side tap water conduit pipe 12B. The tap water is held at a predetermined water pressure, which is usually 2 to 4 kgf/cm², and sometimes becomes more boosted than this value. Thus, this pressure of the tap water potentially has the capability of serving as a driving source.

The aspirator 3 comprises a nozzle section 51 and a diffuser 52. The nozzle section 51 is comprising a nozzle part 53 and a body part 54. The nozzle section 51 has a narrowed portion in the pipe. The flow of the tap water 19 is accelerated at the nozzle section. Along with this, a pressure-reduced part, the pressure of which part is lower than the pressure in the hydrogen gas tank, is formed around the nozzle section. The diffuser 52 forms a high-speed jet blasting part 55 of the tap water 19A jetted from the nozzle 51. The high-speed jet blasting part of the water 19A is comprising a suction section 56 and a compressing and boosting section 57. The suction section 56 forms a pressure reduced area around the nozzle part and causes hydrogen gas to be sucked. The suction section 56 and the compressing and boosting section 57 configure a mixing section 58 that mixes hydrogen gas into the tap water and gradually boosts the tap water pressure.

The construction of aspirator that uses water pressure is a known art.

This embodiment employs the aspirator 3, by which the hydrogen gas is mixed with the tap water, wherein the aspirator uses water pressure and the water pressure of tap water works as a driving source for injecting the hydrogen gas.

A tap water 60 containing hydrogen gas blasted from the aspirator 3 as a discharging stream 59 is branched and supplied to a tap water user 61.

As described above, the tap water supply system is structured into the unitized one-unit configuration 4 comprising the hydrogen gas generator 1 that separates hydrogen gas from oxygen gas and hydrogen gas produced from a water-containing electrolyte using a photocatalyst, the hydrogen gas tank 2, and the aspirator 3.

The hydrogen gas generator 1 is comprising the first chamber-forming part that forms the first chamber which accommodates the electrolyte and the first electrode, the second forming part that forms the second chamber which accommodates the electrolyte and the second electrode, the separation membrane, which partitions between the first chamber and the second chamber, separates the hydrogen gas from oxygen gas, and the direct current power supply that connects the first electrode and the second electrode.

The hydrogen gas produced in the hydrogen gas generator is reserved in the hydrogen tank 2.

The unitized configuration is comprising the hydrogen gas generator 1, the hydrogen gas tank 2, and the hydrogen gas injection device 3 that employs the aspirator. The aspirator that uses water pressure and is arranged on a part of the water conduit pipe as the hydrogen gas injection device 3. As the driving source of the aspirator, the tap water that flows through the water conduit pipe is used and its pressure in the water conduit pipe is maintained at a predetermined pressure. The aspirator has the nozzle part in the narrowed portion of the pipe and the hydrogen gas piping from the hydrogen gas tank is connected to around the nozzle part. The aspirator, which uses a flow of tap water, is employed to create a reduced pressure state by Venturi effect using the flow of the tap water.

The aspirator increases the speed of tap water flow at the nozzle part formed in a narrow portion in the pipe to produce the Venturi effect, which creates a lower pressure state below the pressure of the hydrogen gas tank. The reduced pressure of the tap water stream sucks the hydrogen gas to allow the tap water to contain the hydrogen gas to produce the hydrogen-containing tap water.

Thus, the tap water supply system is constructed, which system supplies the hydrogen-containing tap water produced by the above-stated unit to the tap water user.

Based on the configuration shown in FIGS. 1 and 2, the tap water supply system is provided.

The system is comprising

the hydrogen gas generator that produces the hydrogen gas by separating the hydrogen gas from the oxygen gas and hydrogen gas produced from the water-containing electrolyte using photocatalyst,

wherein the hydrogen gas generator is comprising the first chamber-forming part that forms the first chamber which accommodates the electrolyte and the first electrode, the second forming part that forms the second chamber which accommodates the electrolyte and the second electrode, the separation membrane, which partitions between the first chamber and the second chamber, separates the hydrogen gas from oxygen gas, and the direct current power supply that connects the first electrode and the second electrode,

the hydrogen gas tank that reserves generated hydrogen gas, and

the aspirator arranged on a part of the water conduit pipe,

wherein the aspirator uses the water flow maintained at a predetermined pressure flowing through the water conduit pipe as the driving source of the aspirator,

wherein the aspirator has a nozzle part at a narrowed portion of the water conduit pipe and the hydrogen gas piping from the hydrogen gas tank is connected to around the nozzle part,

wherein the aspirator is employed to create a reduced pressure state by Venturi effect using the flow of tap water,

wherein the hydrogen gas generator, the hydrogen gas tank that reserves the generated hydrogen gas, the hydrogen gas piping, and the aspirator are unitized into the one-unit configuration.

The aspirator increases the speed of the tap water flow at the nozzle part formed in the narrow portion in the water conduit pipe to produce a lower pressure state by Venturi effect below the pressure of the hydrogen gas tank. The low pressure produced in the tap water stream sucks the hydrogen gas to allow the tap water to contain the hydrogen gas to produce the hydrogen-containing tap water. The hydrogen-containing tap water produced by the above-stated unit configuration is supplied to the water user.

### REFERENCE SIGNS LIST

100 . . . Water supply system, tap water supply system
1 . . . Hydrogen gas generator
2 . . . Hydrogen gas tank
3 . . . Hydrogen gas injection device, aspirator
4 . . . Unitized configuration
11 . . . photocatalyst
12 . . . Water conduit pipe
12A . . . Upstream side water conduit pipe
12B . . . Downstream side water conduit pipe
13 . . . Connector pipe
15, 16 . . . Piping
17, 18 . . . Control valve
19 . . . Tap water
50 . . . Building
60 . . . Hydrogen-containing tap water
61 . . . Water user, tap water user

1. A tap water supply system wherein the tap water flowing through a water conduit pipe is branched for supply to a plurality of tap water users, the tap water supply system comprising:
a hydrogen gas generator that produces hydrogen gas by separating the hydrogen gas from oxygen gas and hydrogen gas which are produced from a water-containing electrolyte using a photocatalyst,
a hydrogen gas tank that reserves the produced hydrogen gas,
an aspirator arranged on a part of the water conduit pipe, wherein the aspirator uses tap water flowing through the water conduit pipe as a driving source and has a narrow portion in the water conduit pipe that forms a nozzle part, and
hydrogen gas piping from the hydrogen gas tanks connected to around the periphery of the nozzle part,
wherein the pressure of the tap water flowing through the water conduit pipe is maintained at a predetermined pressure,
wherein the aspirator uses the flow of tap water to create a depressurized state by a Venturi effect, and
wherein the aspirator increases the speed of tap water flow at the nozzle part formed in the narrow portion of the water conduit pipe to create a lower pressure state below the pressure of the hydrogen gas tank by the Venturi effect and suck the hydrogen gas into the depressurized tap water stream to be mixed with the tap water to produce hydrogen-contained tap water for supply to the tap water users.

2. The tap water supply system according to claim 1
wherein the hydrogen gas generator, the hydrogen gas tank, and the aspirator are unitized into a one-unit configuration, and
wherein the hydrogen-containing tap water is produced by the one-unit configuration for supply to the tap water users.

3. A method for supplying tap water by a tap water supply system, the tap water supply system comprising a hydrogen gas generator that separates hydrogen gas from oxygen gas and hydrogen gas produced from water-containing electrolyte using a photocatalyst, a hydrogen gas tank, and a hydrogen gas injection device that includes an aspirator, the method comprising:
reserving the hydrogen gas produced by the hydrogen gas generator in the hydrogen gas tank,
introducing, by the hydrogen gas injection device, the hydrogen gas reserved in the hydrogen gas tank into a water conduit pipe in which tap water is maintained at a predetermined water pressure,
branching the tap water flowing through the water conduit pipe for supply to a plurality of tap water users,
wherein the aspirator is arranged on a part of the water conduit pipe, uses the tap water maintained at a predetermined water pressure flowing through the water conduit pipe as a driving source for injecting hydrogen gas, and has a narrow portion in the water conduit pipe that forms a nozzle part,
wherein a hydrogen gas piping from the hydrogen gas tank is connected to around the nozzle part, and
wherein the aspirator produces a depressurized state by a Venturi effect using the flow of the tap water and increases the speed of tap water flow at the nozzle part in the narrow portion of the water conduit pipe to create a lower pressure state below the pressure of the hydrogen gas tank by the Venturi effect,
sucking the hydrogen gas into the depressurized tap water stream and mixing the sucked hydrogen gas with the tap water to produce hydrogen-containing tap water, and
supplying the produced hydrogen-containing tap water to the tap water users.

4. The method for supplying tap water according to claim 4,
wherein the hydrogen gas generator, the hydrogen gas tank, and the aspirator are unitized into a one-unit configuration.

5. The tap water supply system according to claim 1,
wherein the hydrogen gas generator comprises a first chamber-forming part that forms a first chamber which accommodates a first electrode and an electrolyte, a second forming part that forms a second chamber which accommodates a second electrode and the electrolyte, a separation membrane that partitions the first chamber from the second chamber to separate the hydrogen gas from the oxygen gas, and a direct current power supply that connects the first electrode and the second electrode.

6. The tap water supply system according to claim 2,
wherein the hydrogen gas generator comprises a first chamber-forming part that forms a first chamber which accommodates a first electrode and an electrolyte, a second forming part that forms a second chamber which accommodates a second electrode and the electrolyte, a separation membrane that partitions the first chamber from the second chamber to separate the hydrogen gas from the oxygen gas, and a direct current power supply that connects the first electrode and the second electrode.

7. The method for supplying tap water according to claim 3,
wherein the hydrogen gas generator comprises a first chamber-forming part that forms a first chamber which accommodates a first electrode and an electrolyte, a second forming part that forms a second chamber which accommodates a second electrode and the electrolyte, a separation membrane that partitions the first chamber from the second chamber to separate the hydrogen gas from the oxygen gas, and a direct current power supply that connects the first electrode and the second electrode.

8. The method for supplying tap water according to claim 4,
wherein the hydrogen gas generator is comprising a first chamber-forming part that forms a first chamber which accommodates a first electrode and an electrolyte, and a second forming part that forms a second chamber which accommodates a second electrode and the electrolyte, and a separation membrane that partitions between the first chamber and the second chamber to separate the hydrogen gas from oxygen gas, and a direct current power supply that connects the first electrode and the second electrode,
